(19) United States
(12) Patent Application Publication
(10) Pub. No.: US 2002/0108760 A1
(43) Pub. Date: Aug. 15, 2002

(54) Fire retardant coating composition

(76) Inventor: Thomas Sardo, Florida, NY (US)

Correspondence Address: Philip Furgang, Esq., Furgang & Adwar, L.L.P., Suite 210, 2 Crosfield Avenue, West Nyack, NY, 10994, US

(21) Appl. No.: 09/782,121

(22) Filed: Feb. 13, 2001

(51) Int. Cl. A62C 2/00; C09K 21/00

(52) U.S. Cl. 169/45; 252/601

(57) ABSTRACT

A fire retardant composition including potassium chloride, ammonium borate or ammonium pentaborate, and water. The formulation is transparent in nature and coated onto flammable materials such as wallboard or the like. The formulation is then covered with non-latex paint or a wall covering such as wallpaper.

### BACKGROUND OF THE INVENTION

The invention is directed to a general use fire retardant composition which contains water, potassium chloride, and ammonium borate or ammonium pentaborate.

The composition is useful for coating onto substrates, such as wallboard and the like, for the purpose of retarding the spread or initiation of fires. Potassium and sodium salts have been used for their fire extinguishing properties, and maybe used either in the form of powder or in the form of an aqueous solution to fight fires. Among the extinguishing powders, alkaline metal bicarbonates are also often used, but whereas they are very effective against fires of hydrocarbons or other inflammable liquids, they have a drawback common to all fire extinguishing powders; they have little effect against dry fires, and give only poor results against mixed fires.

We direct your attention to U.S. Pat. No. 3,425,939 which relates to a two-component fire extinguishing composition. Nowhere in this patent is there suggested or discussed, the possibility of combining a potassium salt, such as potassium chloride, with ammonium borate or ammonium pentaborate.

U.S. Pat. No. 2,935,471 discusses compositions useful as flame retardants and to flammable, non-volatile, polymeric organic compounds treated therewith. The patent focuses on compositions consisting essentially of 60-90% by weight of at least one compound selected from the group consisting of ammonium sulfamate, ammonium sulfate, diammonium hydrogen phosphate and monoammonium dihydrogen phosphate, water soluble nitrogenous substances, and a water soluble boron compound. Nowhere does this patent suggest the specific formulation of a potassium chloride, water, and ammonium borate or ammonium pentaborate formulation.

It is objective of this invention, therefore, to provide a fire fighting retardant composition which will be transparent in nature and easily applied to wallboard for subsequent painting or placement of a wall covering, such as wallpaper thereon.

### SUMMARY OF THE INVENTION

To obtain the objects of this invention, there is provided an aqueous fire retardant formulation including water, potassium chloride and ammonium borate or ammonium pentaborate.

This formulation is easily produced by the dry mixing of the borate and salt components prior to addition of the water solvent. Once mixed, the formulation is heated to a temperature of approximately 110° F., an amount just below the formulation's boiling point, to produce the desired transparent coating formulation.

### DETAILED DESCRIPTION OF THE INVENTION

There is provided a fire retardant composition including water, potassium chloride and ammonium borate or ammonium pentaborate. The formulation is transparent and can be applied to various flammable substrates such as wallboard and the like.

A desired formulation contains approximately 100 parts water; approximately 15-20 parts potassium chloride; and approximately 4-6 parts ammonium borate or ammonium pentaborate, with ammonium pentaborate being the preferred component.

The composition is produced by first dry mixing potassium chloride and ammonium borate or ammonium pentaborate to form the desired mixture and maintained at a temperature of 85° F. The mixture is then dissolved in water pre-heated to a temperature of approximately 110° F. or more, just below the mixture's boiling point.

Once produced, the formulation is held at a temperature below 85° F., and preferably at a temperature of approximately 60-70° F.

To produce a fire retardant or fire proofed wall substrate, such as wallboard, the formulation is coated onto the substrate. Once the coating has been applied, it is a requirement for a covering, such as a non-latex paint or a wall covering material, such as wallpaper, to be applied. If a wall covering, such as wallpaper is applied, it is essential that a non-water-based wall covering adhesive paste is utilized to prevent breakdown of the fire retardant composition.

The desired formulation produces an unique fire retardant composition through the combination of unique components. From the foregoing description, one skilled in the art can easily ascertain the essential characteristics of this invention, and without departing from the spirit and scope thereof, can make various changes and modification of the invention to adapt it to various usages and conditions. Consequently, such changes and modifications are properly, equitably, and intended to be, within the full range of equivalents of the following claims.

What is claimed is:

1. A fire retardant composition comprising:
a) water;
b) potassium chloride; and
c) ammonium borate or ammonium pentaborate.

2. The fire retardant composition of claim 1 wherein the composition is 100 parts water; 15-20 parts potassium chloride; and 4-6 parts ammonium pentaborate.

3. The fire retardant composition of claim 1, wherein the composition is transparent.

4. The process of producing a fire retardant composition comprising the steps of:
a) mixing dry potassium chloride and dry ammonium borate, or dry ammonium pentaborate to form a mixture; and
b) maintaining the dry mixture at a temperature below 85° F.; and
c) dissolving the mixture into water at a temperature above 110° F.

5. A process of fireproofing a wall comprising the steps of:
a) coating a substrate with a composition as claimed in claim 1 to form a coated substrate; and
b) covering the coated substrate with a non-latex paint, or a non-water based wall covering adhesive paste where applying a wall covering onto the coated substrate.

6. The process of claim 5, wherein the composition prior to the addition of water is maintained at a temperature below 85° F. prior to use.
